(19) United States
(12) Patent Application Publication
(10) Pub. No.: US 2005/0184279 A1
(43) Pub. Date: Aug. 25, 2005

(54) Round fish tape

(76) Inventors: Frederick James Diggle III, Birmingham, AL (US); Steven Ryals, Pinson, AL (US)

Correspondence Address: LEE & HAYES, PLLC, 421 W. RIVERSIDE AVE., SUITE 500, SPOKANE, WA, 99201, US

(21) Appl. No.: 10/786,733

(22) Filed: Feb. 25, 2004

(51) Int. Cl. B66F 3/00

(52) U.S. Cl. 254/134.3 FT

(57) ABSTRACT

Disclosed is a fish tape comprising a plurality of substantially round forms including a circular outer diameter with and without a cable attaching mechanism, a plurality of facets about the diameter, an elliptical outer diameter, a spiral groove extending along a longitudinal portion, one or more notches about the diameter and forming a repeating pattern along the longitudinal portion, and one or more corrugations about the diameter and extending along the longitudinal portion. Also disclosed is a fish tape device that includes the various fish tape forms described.

### BACKGROUND

The present invention is directed generally and in various embodiments to a fish tape having a substantially cylindrical shape.

Fish tape is often used to fish wires and cable through an area that may not be accessible (e.g., a wall) or through a raceway such as conduit piping. Electricians and/or technicians are often required to install a run of one or more lines or wires (e.g., electrical or communication wire) through lengths of raceways. Raceways may include conduits, ducts and other enclosed channels. A fish tape is commonly sent through the raceway for installing the run of lines or wires. Often the raceway will have angled bends (e.g., 90 degree bends, etc.) and may already have runs of line or wire inside the raceway. FIG. 1 is a diagram illustrating an example of a conventional fish tape device 10. An end 11 of a fish tape 12 extends from a reel assembly 14. The fish tape 12 is wound inside the assembly 14. The fish tape 12 may be constructed of a durable material such as, for example, steel tape. The assembly 14 may include a handle 16 that is used to hold the device 10 in operation and to transport the device 10. The assembly 14 also may include a hand-operated crank or motor-operated device (not shown) that is used to retract the fish tape 12 into the assembly 14. The end 11 of the fish tape 12 terminates with an end device 18. The end device 18 may be, for example, a slotted device that is formed or attached to the fish tape 12 or may be a bend or series of bends formed in the fish tape 12.

FIG. 2 is a side view of the conventional fish tape 12 and FIG. 2A is a top view of the fish tape 12. As shown, the fish tape 12 has a certain thickness 24 and a certain width 26 resulting in a rectangular cross-section 28. The conventional fish tape 12 may have a thickness 24 of about 0.0625″ ( 1/16″) and a width 26 of about 0.375″ (⅜″) for a cross-sectional area 28 of about 0.0234 square inches, for example. Because the conventional fish tape 12 has a rectangular cross-section 28 it has a natural tendency to flex in the direction indicated by arrow 22 and has a natural tendency not to flex readily in the direction indicated by arrow 20. Thus, as illustrated in FIG. 3, if the fish tape 12 is oriented within a wall or a conduit 30 in a certain manner, it may not turn about the bend 52 or elbow in the conduit 30 and the fish tape 12 will not flex around the bend 52 and continue to navigate into the remaining portions of the conduit 30 and may engage an inner wall of the conduit 30 at a high friction point 34 when being forced into the conduit 30 in the direction indicated by arrow 32. In the situation where the fish tape 12 gets stuck, it will not flex or bend in the direction 20 and the fish tape 12 must be completely removed from the conduit 30, rotated approximately 90 degrees and reinserted into the conduit 30. Those skilled the art will appreciate that the reorientation may cause problems at other bends further into the conduit 30. Also, removing the stuck fish tape 12 from the conduit 30 may damage insulation of cables or wires that already may be present within the conduit 30.

### SUMMARY

Embodiments of the present invention are directed to a fish tape. The fish tape includes an end portion and a longitudinal portion comprising an outer diameter defining a substantially cylindrical shape along a longitudinal portion of the fish tape.

Embodiments of the present invention are directed to a fish tape device. The fish tape device includes a fish tape comprising an end portion and a longitudinal portion comprising an outer diameter defining a substantially circular shape along a longitudinal portion of the fish tape; and a reel assembly for receiving the fish tape.

Other apparatuses and systems according to embodiments of the present invention will be or become apparent to one with skill in the art upon examination of the following drawings and detailed description. It is intended that all such additional apparatuses and systems be included within this description, be within the scope of the present invention, and be protected by the accompanying claims.

### BRIEF DESCRIPTION OF THE DRAWINGS

Further advantages of the present invention may be better understood by referring to the following description taken in conjunction with the accompanying drawings, in which:

FIG. 1 is a diagram illustrating an example of a conventional fish tape device;

FIG. 2 is a diagram illustrating a side view of a conventional fish tape;

FIG. 2A is a top view of the conventional fish tape illustrated in FIG. 2;

FIG. 3 is a diagram illustrating a conventional fish tape in a stuck position inside a conduit;

FIG. 4 is a diagram illustrating a side view of a circular fish tape according to one embodiment of the present invention;

FIG. 4A is a top view of the circular fish tape illustrated in FIG. 4;

FIG. 5 is a diagram illustrating a side view of a fish tape according to one embodiment of the present invention;

FIG. 5A is a top view of the fish tape illustrated in FIG. 5;

FIG. 6 is a diagram illustrating a side view of a multifaceted fish tape according to one embodiment of the present invention;

FIG. 6A is a top view of the multifaceted fish tape illustrated in FIG. 6;

FIG. 7 is a diagram illustrating a side view of an elliptical fish tape according to one embodiment of the present invention;

FIG. 7A is a top view of the elliptical fish tape illustrated in FIG. 7;

FIG. 8 is a diagram illustrating a side view of a spiral grooved fish tape according to one embodiment of the present invention;

FIG. 8A is a top view of the spiral grooved fish tape illustrated in FIG. 8;

FIG. 9 is a diagram illustrating a side view of a notched fish tape according to one embodiment of the present invention;

FIG. 9A is a top view of the notched fish tape illustrated in FIG. 9;

FIG. 10 is a diagram illustrating a side view of a corrugated like fish tape according to one embodiment of the present invention;

FIG. 10A is a top view of the corrugated like fish tape illustrated in FIG. 10;

FIG. 11 illustrates the fish tape according to one embodiment of the present invention oriented inside a conduit;

FIG. 12 is a diagram illustrating an example of a fish tape device according to one embodiment of the present invention; and FIG. 13 illustrates a fish tape according to one embodiment of the present invention oriented inside a conduit with one or more bends oriented in different directions.

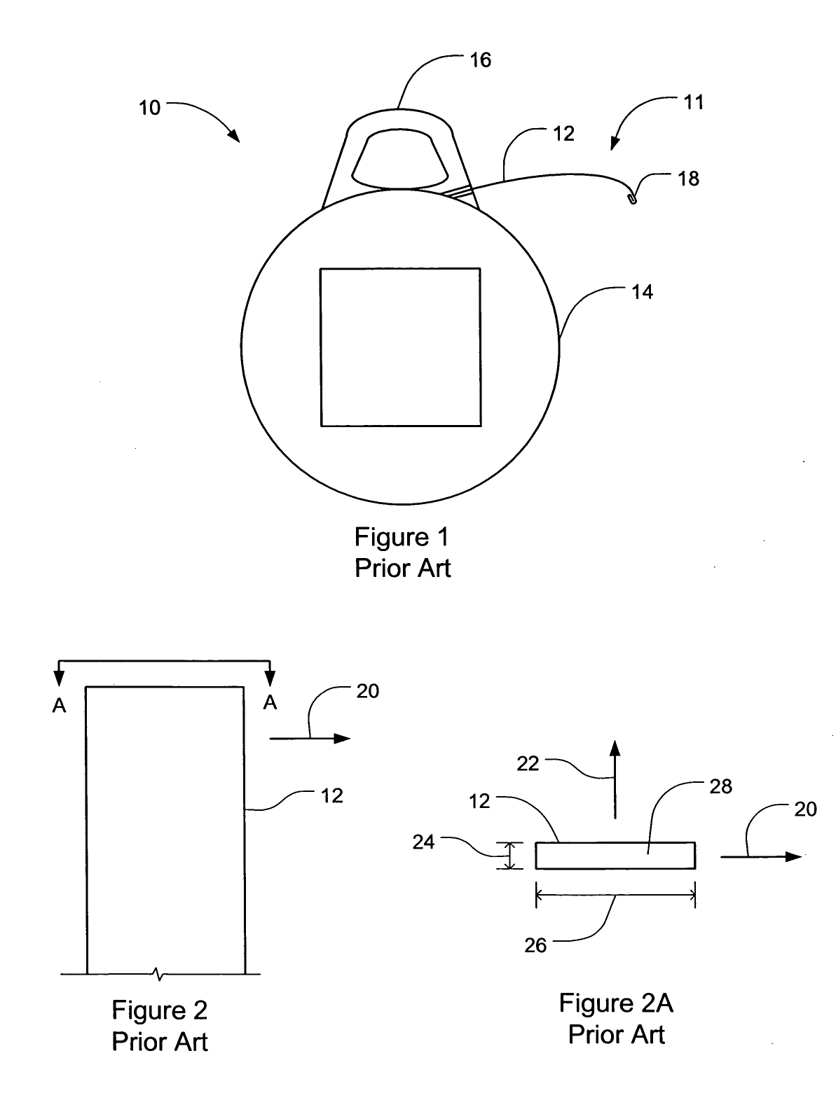

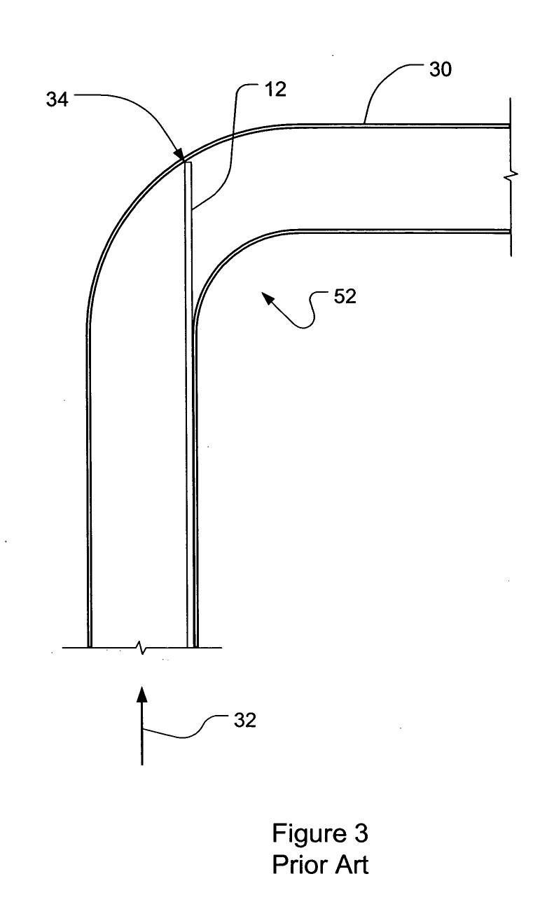

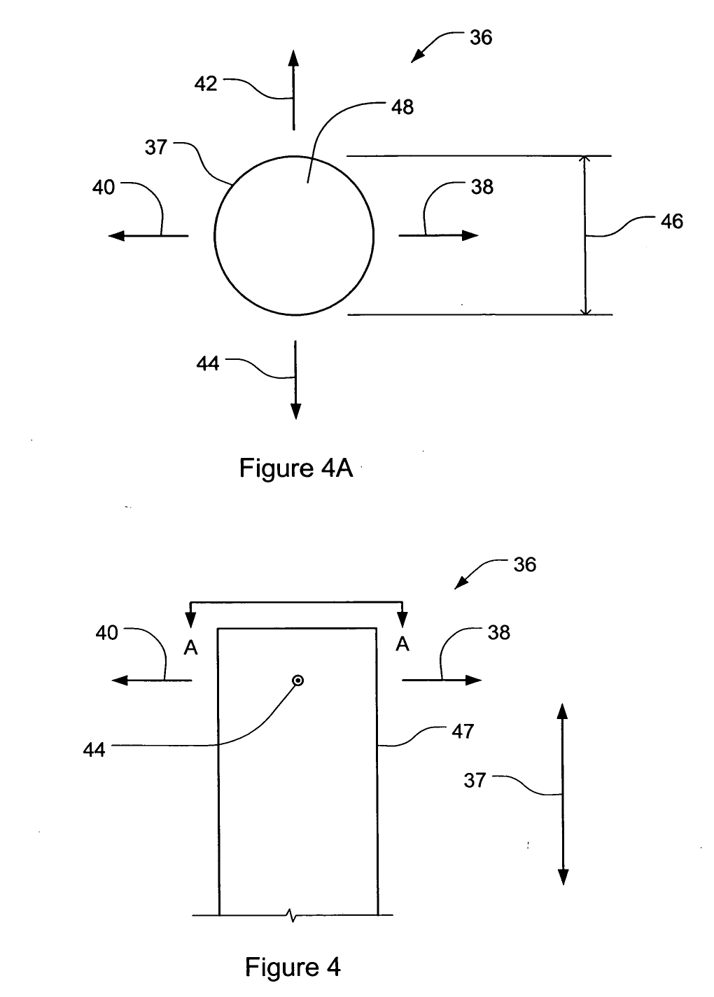

### DESCRIPTION

It is to be understood that the figures and descriptions of the present invention have been simplified to illustrate elements that are relevant for a clear understanding of the present invention, while eliminating, for purposes of clarity, other elements. Those of ordinary skill in the art will recognize, however, that these and other elements may be desirable. However, because such elements are well known in the art, and because they do not facilitate a better understanding of the present invention, a discussion of such elements is not provided herein.

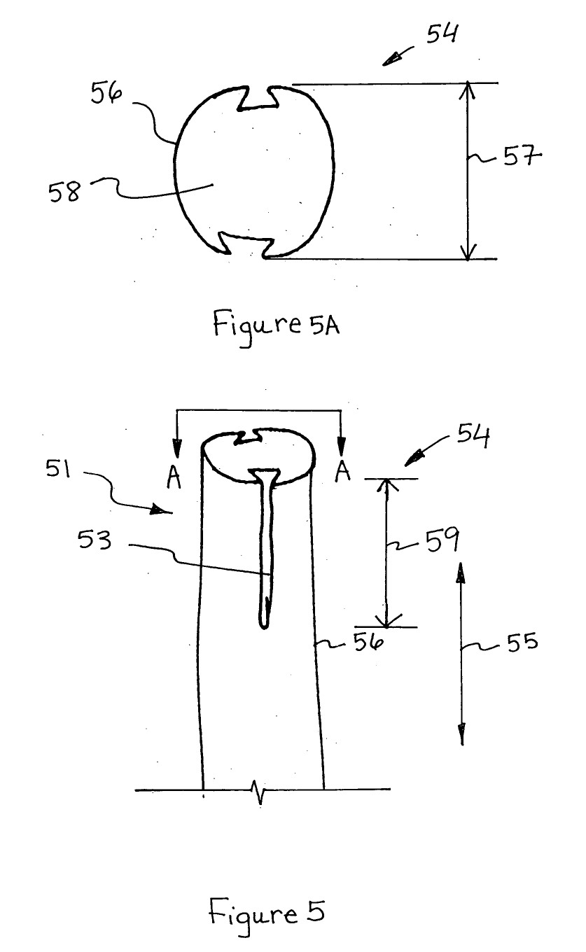

FIG. 4 is a diagram illustrating a side view of a cylindrical-shaped (i.e., circular-shaped in cross-section) fish tape 36 according to one of many embodiments of the present invention. FIG. 4A is a top view of the circular fish tape 36 illustrated in FIG. 4. The circular fish tape 36 comprises a substantially cylindrical shape along a longitudinal portion 37 of the circular fish tape 36 having a diameter 47. The circular fish tape 36 defines a circular cross-sectional area 48. The substantially cylindrical shape of the circular fish tape 36 allows the circular fish tape 36 to flex substantially equally in the directions indicated by arrows 38, 40, 42, 44 giving the circular fish tape 36 multiple degrees of freedom of flexure and movement, and in various embodiments of the present invention, giving the circular fish tape 36 omni-directional degrees of freedom of flexure and movement.

In one of many embodiments of the present invention, the circular fish tape 36 has a maximum outer diameter 46 of about 0.1875″ ( 3/16″), for example, and a corresponding cross-sectional area 48 of about 0.02761 square inches, for example. In one of many embodiments of the present invention the circular fish tape 36 has a maximum outer diameter 46 of about 0.375″ (⅜″), for example, and a corresponding cross-sectional area 48 of about 0.1104 square inches, for example. Furthermore, any circular fish tape 36 with a diameter 48 ranging between approximately 0.1875″ ( 3/16″) and approximately 0.375″ (⅜″) will generally have an adequate stiffness required to navigate within a wall or the conduit 30 while retaining the required flexibility in the directions indicated by arrows 38, 40, 42, 44 so as to minimize or eliminate any possibility of the circular fish tape 36 getting stuck inside the conduit 30.

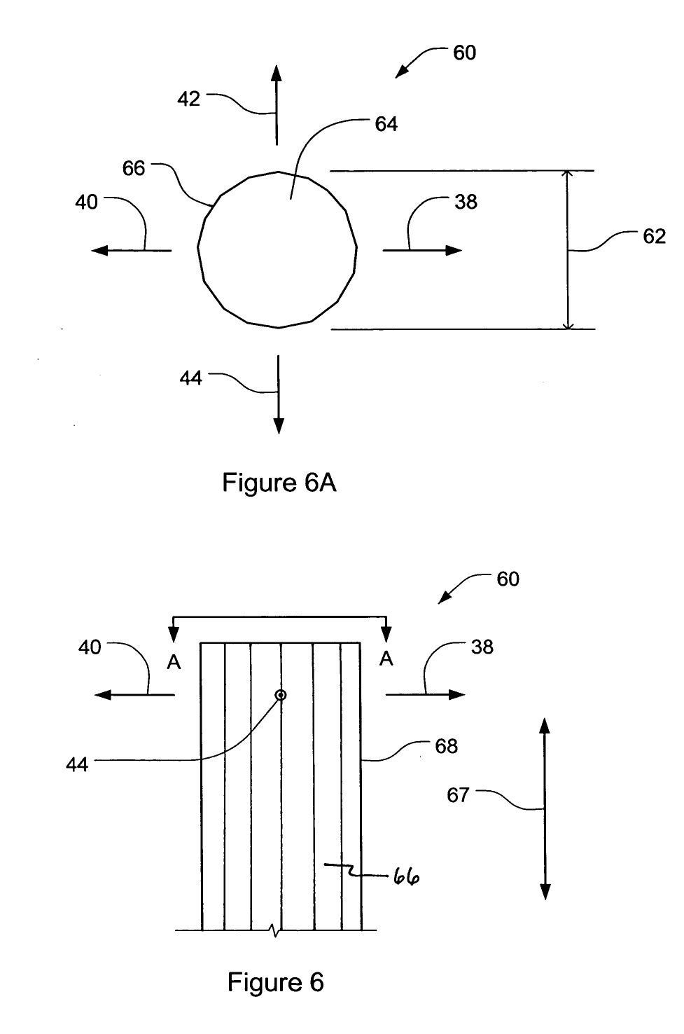

FIG. 5 is a diagram illustrating a side view of a fish tape 54 according to one of many embodiments of the present invention. FIG. 5A is a top view of the fish tape 54 illustrated in FIG. 5. The fish tape 54 comprises a substantially cylindrical shape along a longitudinal portion 55 of the circular fish tape 54 having a diameter 56. The fish tape 54 defines a circular cross-sectional area 58. The substantially cylindrical shape of the fish tape 54 allows it to flex substantially equally in the directions indicated by arrows 38, 40, 42, 44 giving the fish tape 54 multiple degrees of freedom of flexure and movement, and in various embodiments of the present invention, giving the fish tape 54 omni directional degrees of freedom of flexure and movement. In addition, the fish tape 54 further comprises an end portion 51 including a plurality of grooves 53 extending partially along the longitudinal axis 55 of the fish tape 54 for a length indicated by 59. The grooves 53 provide a mechanism for attaching a plurality of wire or cable engaging attachments to the end portion 51 of the fish tape 54.

In one of many embodiments of the present invention, the fish tape 54 has a diameter 56 of about 0.1875″ ( 3/16″), for example, and a corresponding cross-sectional area 58 of about 0.02761 square inches, for example. In one of many embodiments of the present invention the fish tape 54 has a diameter 56 of about 0.375″ (⅜″), for example, and a corresponding cross-sectional area 58, for example. Furthermore, any fish tape 54 with a maximum outer diameter 57 ranging between approximately 0.1875″ ( 3/16″) and approximately 0.375″ (⅜″) will generally have an adequate stiffness required to navigate within a wall or the conduit 30 while retaining the required flexibility in the directions indicated by arrows 38, 40, 42, 44 so as to minimize or eliminate any possibility of the fish tape 54 getting stuck inside the conduit 30.

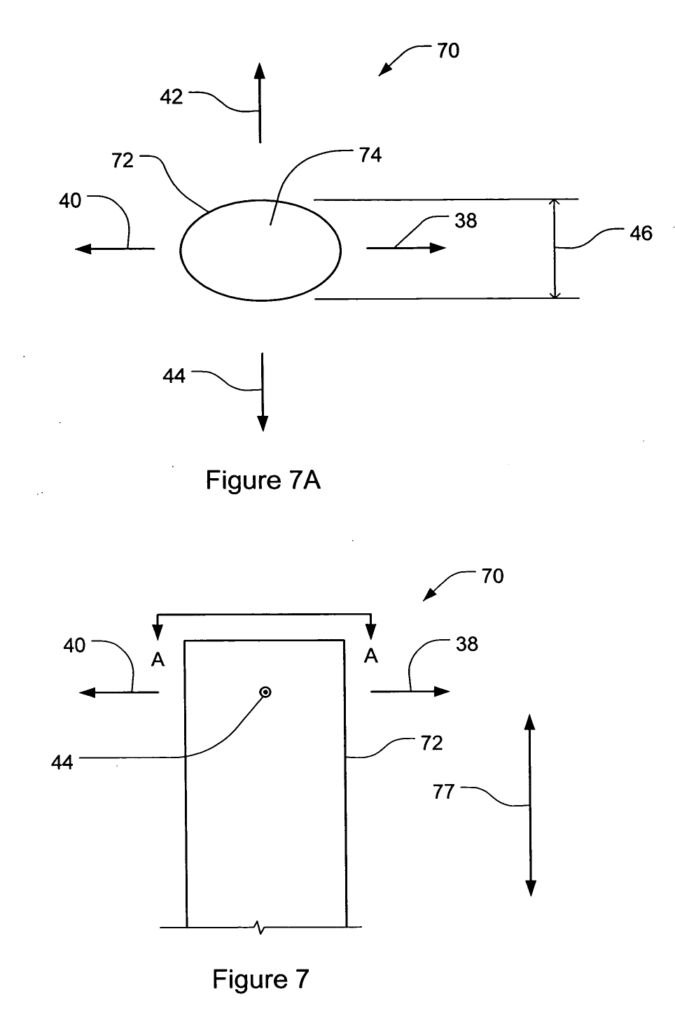

FIG. 6 is a diagram illustrating a side view of a multifaceted fish tape 60 according to one of many embodiments of the present invention. The multifaceted fish tape 60 includes a plurality of facets 66 about the diameter 68 extending along a longitudinal portion 67 of the multifaceted fish tape 60. The multifaceted fish tape 60 also defines a substantially circular cross-sectional area 64 and thus can easily flex around bends 52 in the conduit 30. FIG. 6A is a top view of the multifaceted fish tape 60 illustrated in FIG. 6. The multifaceted fish tape 60 comprises a substantially cylindrical shape along the longitudinal portion with a maximum outer diameter 62. The multifaceted fish tape 60 comprises a circular-like cross-sectional area 64. The substantially cylindrical shape of the multifaceted fish tape 60 also allows it to flex substantially equally in the directions indicated by arrows 38, 40, 42, 44 giving the multifaceted fish tape 60 multiple degrees of freedom of flexure and movement, and in various embodiments of the present invention, giving the multifaceted fish tape 60 omni-directional degrees of freedom of flexure and movement.

In one of many embodiments of the present invention, the multifaceted fish tape 60 has a maximum outer diameter 62 of about 0.1875″ ( 3/16″), for example, and a corresponding cross-sectional area 62. In one of many embodiments of the present invention the multifaceted fish tape 60 has a maximum diameter 62 of about 0.375″ (⅜″), for example, and a corresponding cross-sectional area 64 of about 0.1104 square inches, for example. Furthermore, any multifaceted fish tape 60 with a diameter 62 ranging between approximately 0.1875″ ( 3/16″) and approximately 0.375″ (⅜″) will generally have an adequate stiffness required to navigate within a wall or the conduit 30 while retaining the required flexibility in the directions indicated by arrows 38, 40, 42, 44 so as to minimize or eliminate any possibility of the multifaceted fish tape 60 getting stuck inside the conduit 30.

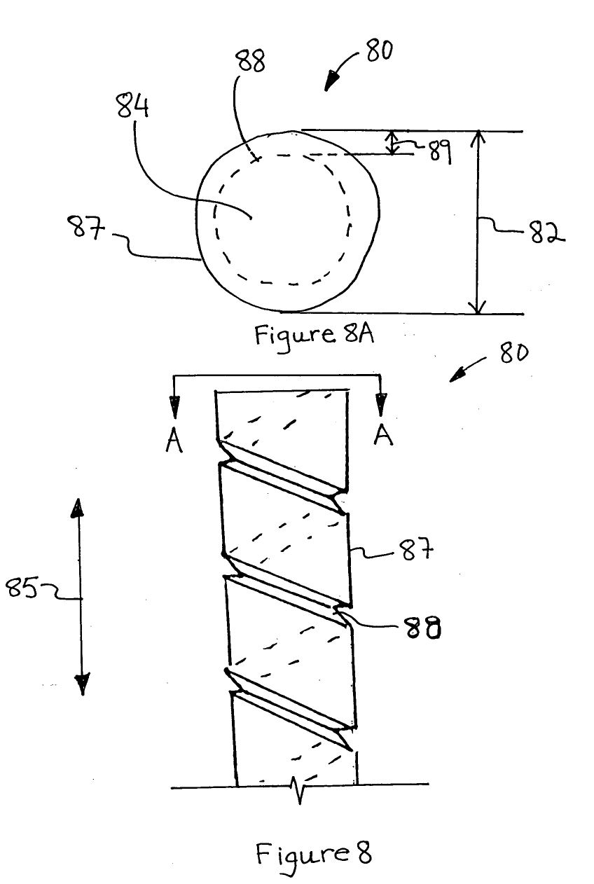

FIG. 7 is a diagram illustrating a side view of an elliptical-shaped fish tape 70 according to one of many embodiments of the present invention. The elliptical fish tape 70 defines an oval shape along a longitudinal portion 77 of the elliptical fish tape 70 and also defines a cross-sectional area 74 such that it can easily flex around bends 52 in the conduit 30. FIG. 7A is a top view of the elliptical fish tape 70 illustrated in FIG. 7. The elliptical fish tape 70 comprises an ellipsoidal substantially cylindrical shape having a maximum outer diameter 72. The elliptical fish tape 70 defines an ellipsoidal cross-sectional area 74. The ellipsoidal substantially cylindrical shape of the elliptical fish tape 70 also allows it to flex substantially equally in the directions indicated by arrows 38, 40, 42, 44 giving the elliptical fish tape 70 multiple degrees of freedom of flexure and movement. Those skilled in the art will appreciate that the elliptical fish tape 70 may have greater flexibility in the directions indicated by the arrows 42 and 44 than in the directions indicated by the arrows 38 and 40, while exhibiting greater overall flexibility in all four directions 38, 40, 42, 44 that the conventional rectangular fish tape 12, for example.

In one of many embodiments of the present invention, the elliptical fish tape 70 has a maximum outer diameter 72 of about 0.1875″ ( 3/16″), for example, and a corresponding cross-sectional area 74, for example. In one of many embodiments of the present invention the elliptical fish tape 70 has a maximum outer diameter 72 of about 0.375″ (⅜″), for example, and a corresponding cross-sectional area 74, for example. Furthermore, any elliptical fish tape 70 with a maximum outer diameter 72 ranging between approximately 0.1875″ ( 3/16″) and approximately 0.375″ (⅜″) will generally have an adequate stiffness required to navigate within a wall or the conduit 30 while retaining the required flexibility in the directions indicated by arrows 38, 40, 42, 44 so as to minimize or eliminate any possibility of the elliptical fish tape 70 getting stuck inside the conduit 30.

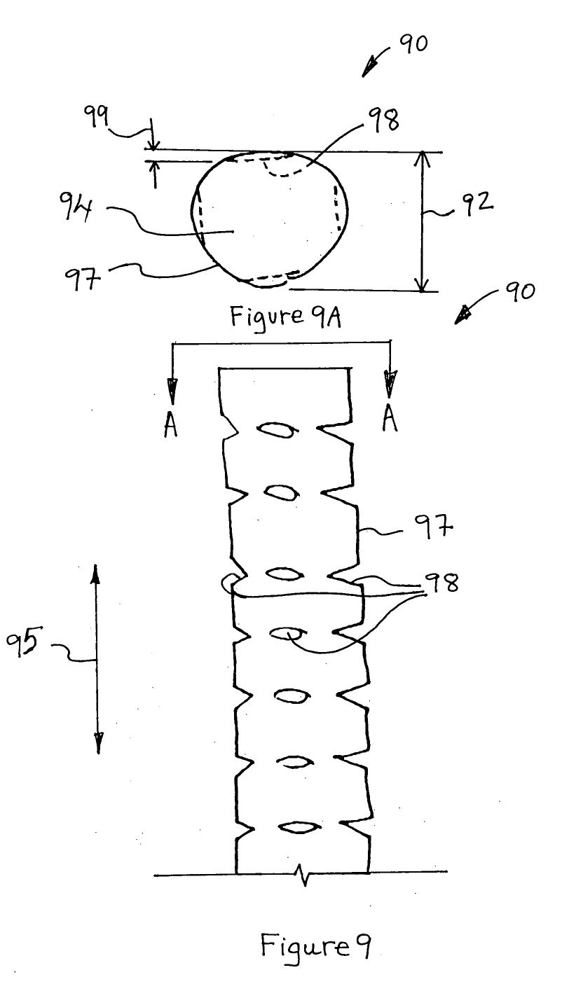

FIG. 8 is a diagram illustrating a side view of a spiral grooved fish tape 80 according to one of many embodiments of the present invention. The spiral grooved fish tape 80 has a substantially cylindrical shape along a longitudinal portion 85 and defines a circular cross-sectional area 84. Thus, it can easily flex around bends 52 in the conduit 30. FIG. 8A is a top view of the spiral grooved fish tape 80 illustrated in FIG. 8. The spiral grooved fish tape 80 comprises a circular outer diameter 87 portion defining a maximum outer diameter 82 and further defining a spiral groove 88 along the outer diameter portion 87 running long a substantial length of the grooved fish tape 80 having depth 89. Further, the spiral grooved fish tape 80 defines a substantially circular cross-sectional area 84. The substantially cylindrical shape of the spiral grooved fish tape 80 and the spiral groove 88 feature also allows it to flex substantially equally in the directions indicated by arrows 38, 40, 42, 44 giving the spiral grooved fish tape 80 multiple degrees of freedom of flexure and movement. Those skilled in the art will appreciate that the spiral grooved fish tape 80 may have greater flexibility in the directions indicated by the arrows 42 and 44 than in the directions indicated by the arrows 38 and 40, while exhibiting overall flexibility in the all four directions 38, 40, 42, 44 that the conventional rectangular fish tape 12, for example, and thus having greater degrees of freedom of flexure and movement than the conventional rectangular fish tape 12.

In one of many embodiments of the present invention, the spiral grooved fish tape 80 has a maximum outer diameter 82 of about 0.1875″ ( 3/16″), for example, and a corresponding cross-sectional area 84, for example. In one of many embodiments of the present invention the spiral grooved fish tape 80 has a maximum outer diameter 82 of about 0.375″ (⅜″), for example, and a corresponding cross-sectional area 84, for example. Furthermore, any spiral grooved fish tape 80 with a maximum outer diameter 82 ranging between approximately 0.1875″ ( 3/16″) and approximately 0.375″ (⅜″) will generally have an adequate stiffness required to navigate within a wall or the conduit 30 while retaining the required flexibility in the directions indicated by arrows 38, 40, 42, 44 so as to minimize or eliminate any possibility of the spiral grooved fish tape 80 getting stuck inside the conduit 30.

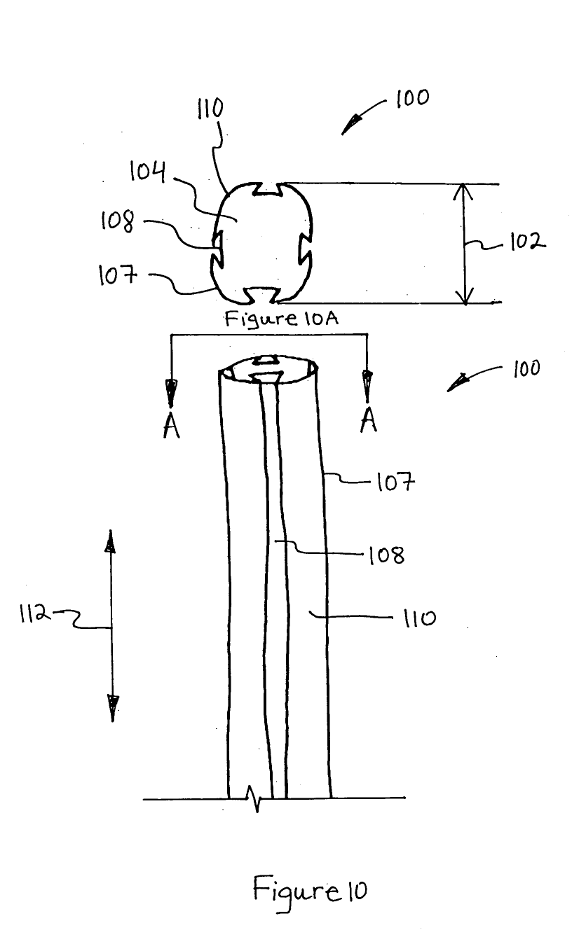

FIG. 9 is a diagram illustrating a side view of a notched fish tape 90 according to one of many embodiments of the present invention. The notched fish tape 90 defines a substantially cylindrical shape along a longitudinal portion 95 and a circular cross-sectional area 94. Thus, it can easily flex around bends 52 in the conduit 30. FIG. 9A is a top view of the notched fish tape 90 illustrated in FIG. 9. The notched fish tape 90 comprises a circular outer diameter 97 portion defining a maximum outer diameter 92 and further defining one or more notches 98 about the outer diameter 97 portion having depth 99. The one or more notches 98 form a repeating pattern along the longitudinal portion 95. In one of many embodiments of the present invention the notched fish tape 90 comprises four notches around the outer diameter spaced apart by 90°. Further, the notched fish tape 90 defines a substantially circular cross-sectional area 94. The substantially cylindrical shape of the notched fish tape 90 including the notches 98 facilitate the flexure of the notched fish tape 90 and also allow it to flex substantially equally in the directions indicated by arrows 38, 40, 42, 44 giving the notched fish tape 90 multiple degrees of freedom of flexure and movement. Those skilled in the art will appreciate that the notched fish tape 90 may have greater flexibility in the directions indicated by the arrows 42 and 44 than in the directions indicated by the arrows 38 and 40, while exhibiting greater overall flexibility in the all four directions 38, 40, 42, 44 that the conventional rectangular fish tape 12, for example.

In one of many embodiments of the present invention, the notched fish tape 90 has a maximum outer diameter 92 of about 0.1875″ ( 3/16″), for example, and a corresponding cross-sectional area 94, for example. In one of many embodiments of the present invention the notched fish tape 90 has a maximum outer diameter 92 of about 0.375″ (⅜″), for example, and a corresponding cross-sectional area 94, for example. Furthermore, any notched fish tape 90 with a maximum outer diameter 92 ranging between approximately 0.1875″ ( 3/16″) and approximately 0.375″ (⅜″) will generally have an adequate stiffness required to navigate within a wall or the conduit 30 while retaining the required flexibility in the directions indicated by arrows 38, 40, 42, 44 so as to minimize or eliminate any possibility of the notched fish tape 90 getting stuck inside the conduit 30 or wall.

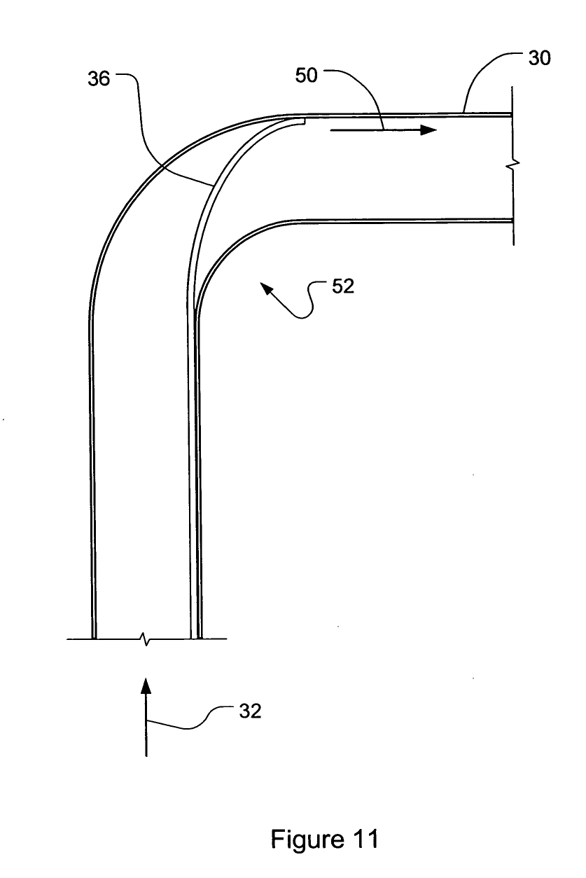

FIG. 10 is a diagram illustrating a side view of a corrugated like fish tape 100 according to one of many embodiments of the present invention. The corrugated like fish tape 100 defines a substantially cylindrical shape along a longitudinal portion 112 and a circular cross-sectional area 104. Thus, can easily flex around bends 52 in the conduit 30. FIG. 10A is a top view of the corrugated like fish tape 100 illustrated in FIG. 10. The corrugated like fish tape 100 comprises a circular outer diameter 107 portion defining a maximum outer diameter 102 and further including one or more corrugations defining one or more alternating grooves 108 and ridges 110 extending along the longitudinal portion 112 of the corrugated like fish tape 100. In one of many embodiments of the present invention the corrugated like fish tape 100 comprises four corrugations around the outer diameter spaced apart by 90°. Further, the corrugated like fish tape 100 also defines a cross-sectional area 104. The substantially cylindrical shape of the corrugated like fish tape 100 and the longitudinally extending grooves 108 facilitates the flexure of the corrugated like fish tape 100 and also allows it to flex substantially equally in the directions indicated by arrows 38, 40, 42, 44 giving the corrugated like fish tape 100 multiple degrees of freedom of flexure and movement. Those skilled in the art will appreciate that the corrugated like fish tape 100 may have greater flexibility in the directions indicated by the arrows 42 and 44 than in the directions indicated by the arrows 38 and 40, while exhibiting greater overall flexibility in the all four directions 38, 40, 42, 44 that the conventional rectangular fish tape 12.

In one of many embodiments of the present invention, the corrugated like fish tape 100 has a maximum outer diameter 102 of about 0.1875″ ( 3/16″), for example, and a corresponding cross-sectional area 104, for example. In one of many embodiments of the present invention the corrugated like fish tape 100 has a maximum outer diameter 102 of about 0.375″ (⅜″), for example, and a corresponding cross-sectional area 104, for example. Furthermore, any corrugated like fish tape 100 with a maximum outer diameter 102 ranging between approximately 0.1875″ ( 3/16″) and approximately 0.375″ (⅜″) will generally have an adequate stiffness required to navigate within a wall or the conduit 30 while retaining the required flexibility in the directions indicated by arrows 38, 40, 42, 44 so as to minimize or eliminate any possibility of the corrugated like fish tape 100 getting stuck inside the conduit 30 or wall.

Embodiments of the present invention include any of the fish tape 36, 60, 70, 80, 90, 100 embodiments described above with respect to FIGS. 4, and 6-10 that include an end portion such as that described with respect to FIG. 4. For example, any of the fish tape 36, 60, 70, 80, 90, 100 embodiments include an end portion 51 including a plurality of grooves 53 about a diameter 56 extending partially along the longitudinal axis 55 of the fish tape 36, 60, 70, 80, 90, 100. The end portion 51 comprising the grooves 53 can be fixedly attached to the an end portion of the fish tape 36, 60, 70, 80, 90, 100 or it can be formed integrally therewith. As discussed previously, the grooves 53 provide a mechanism for attaching a plurality of wire or cable engaging attachments to the end portion 51 of the fish tape 36, 60, 70, 80, 90, 100.

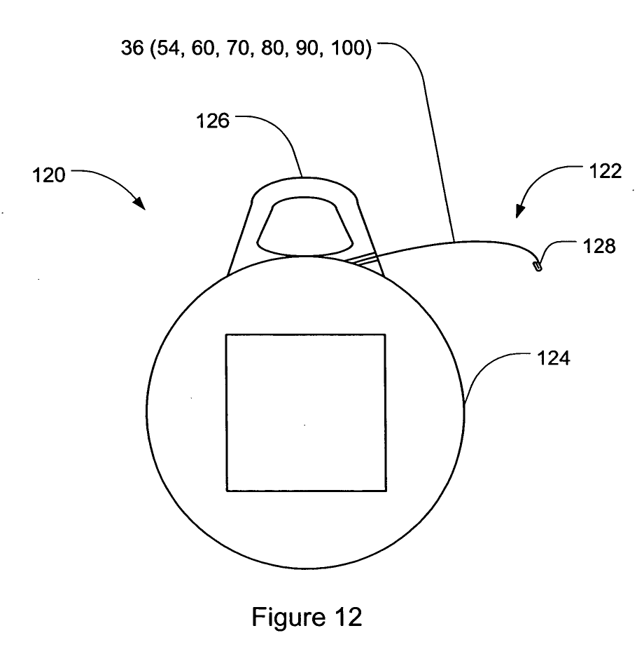

FIG. 11 illustrates the fish tape 36, 54, 60, 70, 80, 90, 100 according to one of many embodiments of the present invention oriented inside a conduit 30. The fish tape 36, 54, 60, 70, 80, 90, 100 is pushed into the conduit in the direction indicated by arrow 32. At a bent portion of the conduit 30, for example, at the 90° bend 52 or elbow, the circular shape of the fish tape 36, 54, 60, 70, 80, 90, 100 allows it to navigate such bends 52 or angles. Accordingly, the fish tape 36, 54, 60, 70, 80, 90, 100 easily flexes into the bend 52 and continues to navigate into the remaining portions of the conduit 30 along the direction indicated by arrow 50. The fish tape's 36, 54, 60, 70, 80, 90, 100 combined stiffness and flexibility allows it to be guided into the conduit 30 while at the same time maintaining its omni directional flexibility to avoid being stuck inside the conduit 30. Thus, the fish tape 36, 54, 60, 70, 80, 90, 100 will easily flex into other bends in the conduit 30 even if they are oriented in different directions from the bend 52.

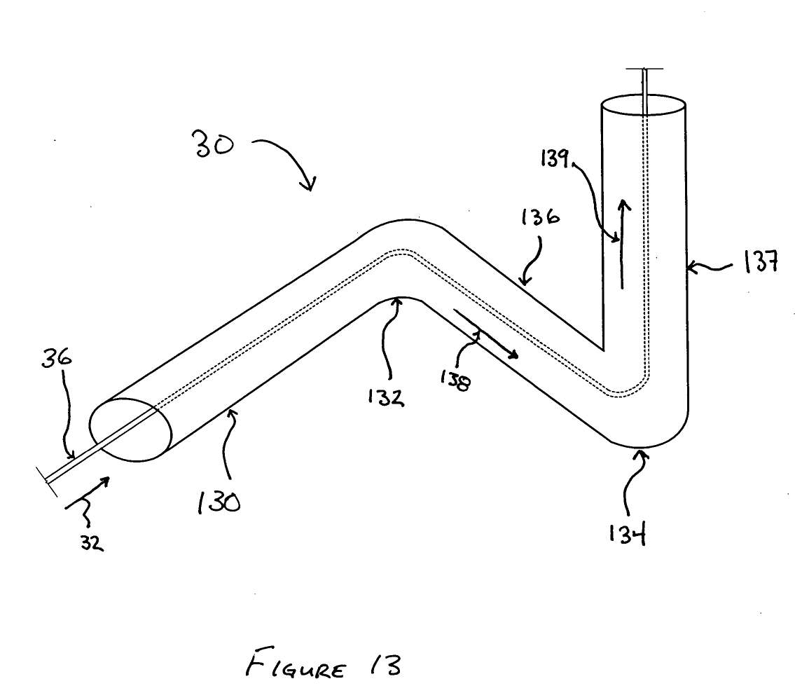

FIG. 12 is a diagram illustrating an example of a fish tape device 120 according to one of many embodiments of the present invention. An end 122 of a fish tape 36, 54, 60, 70, 80, 90, 100 extends from a reel assembly 124. The fish tape 36, 54, 60, 70, 80, 90, 100 is wound inside the assembly 124. The assembly 124 may include a handle 126 that is used to hold the device 120 in operation and to transport the device 120. The assembly 124 also may include a hand-operated crank or motor-operated device (not shown) that is used to retract the fish tape 36, 54, 60, 70, 80, 90, 100 into the assembly 124. The end 122 of the fish tape 36, 54, 60, 70, 80, 90, 100 terminates with an end device 128. The end device 128 may be, for example, a slotted device that is formed or attached to the fish tape 36, 54, 60, 70, 80, 90, 100 or may be a bend or series of bends formed in the fish tape 36, 54, 60, 70, 80, 90, 100. In one of many embodiments of the present the invention, the fish tape device 120 is outfitted with an end device that engages the fish tape 54.

FIG. 13 illustrates the fish tape 36, 54, 60, 70, 80, 90, 100 according to one of many embodiments of the present invention oriented inside a conduit 30 which possesses one or more bends or elbows, for example a first bend 132 and a second bend 134. The fish tape 36, 54, 60, 70, 80, 90, 100 is pushed into the front portion of conduit 130 in the direction indicated by arrow 32. At a first bent portion of the conduit 30, for example, at the first bend 132, the circular shape of the fish tape 36, 54, 60, 70, 80, 90, 100 allows it to navigate the first bend 132. Accordingly, the fish tape 36, 54, 60, 70, 80, 90, 100 flexes into the bend 132 and continues to navigate into the central portion 136 of the conduit 30 along the direction indicated by arrow 138. At a second bent portion of the conduit 30, for example, at the second bend 134, which in this example is orthogonal to the first bend 132, the circular shape of fish tape 36, 54, 60, 70, 80, 90, 100 allows it to navigate the second bend 134 by flexing in a direction that is different than the direction of flex at the first bend 132. The fish tape 36, 54, 60, 70, 80, 90, 100 continues to navigate the end portion 137 of the conduit 30 along the direction indicated by arrow 139. The fish tape's 36, 54, 60, 70, 80, 90, 100 combined stiffness and flexibility allows it to be guided into the conduit 30 while at the same time maintaining its omni directional flexibility to avoid being stuck inside the conduit. Thus, the fish tape 36, 54, 60, 70, 80, 90, 100 can flex into still other bends in the conduit 30 even if they are oriented in different directions from the first bend 132 and the second bend 134. Those skilled in the art will appreciate that the central portion 136 of the conduit 30 may be oriented at any angle relative to the front portion 130 of the conduit 30 to create an angled bend of varying degrees from 0° to 360°, for example. Similarly, the central portion 136 of the conduit 30 may be oriented at any angle relative to the end portion 137 of the conduit 30 to create an angled bend of varying degrees from 0° to 360°, for example.

In one of many embodiments of the present invention, the fish tape 36, 54, 60, 70, 80, 90, 100 is constructed of a material that has high durability and low friction resistance such as, for example, metals and alloys, such as, for example, steel, stainless steel, and carbon steel, or plastics.

Although the present invention has been described with regard to certain embodiments, those of ordinary skill in the art will recognize that many modifications and variations of the present invention may be implemented. The foregoing description and the following claims are intended to cover all such modifications and variations. Furthermore, the components and processes disclosed are illustrative, but are not exhaustive. Other components and processes also may be used to make systems and methods embodying the present invention.

1. A fish tape, comprising:
an end portion; and
a longitudinal portion comprising an outer diameter defining a substantially cylindrical shape along a longitudinal portion of the fish tape.

2. The fish tape of claim 1, further comprising a plurality of grooves for engaging an attachment mechanism formed on the end portion, the grooves extending from the end portion partially along the longitudinal portion, the grooves.

3. The fish tape of claim 1, wherein the fish tape portion is constructed of a material selected from the group consisting of steel, stainless steel, carbon steel, and plastic.

4. The fish tape of claim 1, wherein the outer diameter further comprises a plurality of facets about the outer diameter and extending along the longitudinal portion.

5. The fish tape of claim 1, wherein the outer diameter defines an ellipsoidal shape defining a substantially oval outer diameter.

6. The fish tape of claim 1, further comprising a spiral groove defined along the outer diameter and extending along the longitudinal portion.

7. The fish tape of claim 1, further comprising at least one notch about the diameter, and a plurality of the notches along the longitudinal portion forming a repeating pattern along the longitudinal portion.

8. The fish tape, of claim 7, wherein the outer diameter comprises notches spaced apart about the diameter, and wherein a plurality of the spaced apart notches form a repeating pattern along the longitudinal portion.

9. The fish tape of claim 1, further comprising a corrugation defining an alternating groove and a ridge extending about the diameter and extending along the longitudinal portion.

10. The fish tape of claim 9, wherein the outer diameter comprises corrugations spaced apart about the diameter.

11. A fish tape device, comprising:
a fish tape comprising an end portion and a longitudinal portion comprising an outer diameter defining a substantially cylindrical shape along a longitudinal portion of the fish tape; and
a reel assembly for receiving the fish tape.

12. The fish tape device of claim 11, further comprising a plurality of grooves for engaging an attachment mechanism formed on the end portion, the grooves extending from the end portion partially along the longitudinal portion, the grooves.

13. The fish tape device of claim 11, wherein the fish tape portion is constructed of a material selected from the group consisting of steel, stainless steel, carbon steel, and plastic.

14. The fish tape device of claim 11, wherein the outer diameter of the fish tape further comprises a plurality of facets about the outer diameter and extending along the longitudinal portion.

15. The fish tape device of claim 11, wherein the outer diameter of the fish tape defines an ellipsoidal shape defining a substantially oval outer diameter.

16. The fish tape device of claim 11, wherein the fish tape further comprises a spiral groove defined along the outer diameter and extending along the longitudinal portion.

17. The fish tape device of claim 11, wherein the fish tape device further comprises a plurality of notches about the diameter and extending along the longitudinal portion, and wherein the plurality of notches form a repeating pattern along the longitudinal portion.

18. The fish tape of claim 11, wherein the fish tape further comprises a plurality of corrugations defining a plurality of alternating grooves and ridges extending about the diameter and extending along the longitudinal portion.

19. A fish tape, comprising:
an end portion;
a longitudinal portion comprising an outer diameter defining a substantially cylindrical shape along a longitudinal portion of the fish tape; and
means for flexing the fish tape.

20. The fish tape of claim 19, further comprising means for engaging an attachment mechanism formed on the end portion, the means for engaging extending from the end portion partially along a longitudinal portion of the fish tape.
